(19) United States
(12) Patent Application Publication
(10) Pub. No.: US 2019/0139307 A1
(43) Pub. Date: May 9, 2019

(54) Modifying a Simulated Reality Display Based on Object Detection

(71) Applicant: Motorola Mobility LLC, Chicago, IL (US)

(72) Inventor: Jun-Ki Min, Chicago, IL (US)

(73) Assignee: Motorola Mobility LLC, Chicago, IL (US)

(21) Appl. No.: 15/808,755

(22) Filed: Nov. 9, 2017

(51) Int. Cl. G06T 19/00; G06F 3/01; G06T 15/00; H04N 5/225; G06K 9/00; A63F 13/53

(52) U.S. Cl. CPC G06T 19/006; G06F 3/011; G06F 3/016; G06T 15/00; A63F 2300/8082; G06K 9/00671; A63F 13/53; G06T 2219/004; H04N 5/225

(57) ABSTRACT

Various implementations modify a simulated display based upon object detection. A simulated reality device displays at least some computer-generated graphics on a display. In some implementations, the computer-generated graphics are visually overlaid on a real world scene to provide augmented information. Alternately or additionally, the computer-generated graphics visually replace a user's view of the real world scene to provide a virtual reality. While displaying the computer-generated graphics, the simulated reality device detects a real world object, such as by detecting the real world object is within a predetermined distance of the simulated reality device and/or by detecting the real world object is moving in one or more directions. Upon detecting the real world object, various implementations of the simulated reality device modify the computer-generated graphics to display a notification of the real world object.

### BACKGROUND

Simulated reality systems provide users with a reality experience that differs from the real word. For example, a virtual reality (VR) system simulates a fictitious world such that the user experiences tactile feedback, noises, and/or visual feedback corresponding to the fictitious world. As another example, an augmented reality (AR) system overlays additional information, data, and/or images over an image capture and/or view of the real world to simulate a reality that visually displays computer-generated information integrated with views of the real word. Oftentimes, users become so engrossed in viewing simulated reality content that they become distracted from observing real word events and/or objects, thus creating a potential hazard to the user and/or those around them.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment that includes an example of a computing device that can perform obstacle notification in a simulated realty system in accordance with one or more implementations;

FIG. 2 illustrates a more detailed example of a computing device that can perform obstacle notification in a simulated realty system in accordance with one or more implementations;

FIG. 3 illustrates an example of simulated reality content obscuring real world objects in accordance with one or more implementations;

FIG. 4 illustrates an example of real world object detection in accordance with one or more implementations;

FIGS. 5a-5c illustrate examples of modifying simulated reality content based on object detection in accordance with one or more implementations;

FIG. 6 illustrates an example of simulated reality content obscuring real world objects in accordance with one or more implementations;

FIGS. 7a-7c illustrate examples of modifying simulated reality content based on object detection in accordance with one or more implementations;

FIG. 8 is a flow diagram that modifies simulated reality based on detecting a real world object in accordance with one or more implementations; and

FIG. 9 is an illustration of an example device in accordance with one or more implementations.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Various implementations modify a simulated display based upon object detection. A simulated reality device displays at least some computer-generated graphics on a display, such as by visually overlaying the computer-generated graphics on a real world scene to provide augmented information and/or visually replacing the real world scene with the computer-generated graphics to provide a virtual reality. While displaying the computer-generated graphics, various implementations of the simulated reality device detect a real world object, and modify the computer-generated graphics to provide a visual notification of the real world object.

Consider now an example environment in which various aspects as described herein can be employed.

### Example Environment

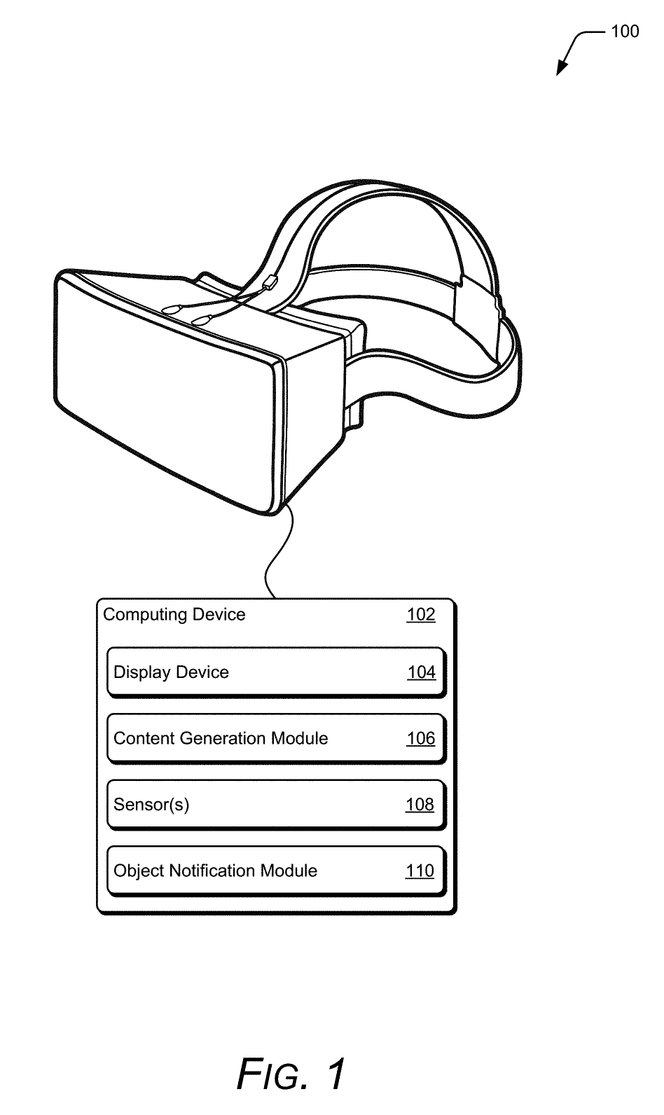

FIG. 1 illustrates an example environment 100 in accordance with one or more implementations. Environment 100 includes a simulated reality computing device 102 (referred to herein as a “simulated reality device”) that represents a computing device capable of providing a user with a simulated reality experience. Here, the simulated reality device is illustrated in the form of virtual reality (VR) glasses, but other types of simulated reality devices can be utilized as well without departing from the scope of the claimed subject matter. While simulated reality device 102 is illustrated here as a stand-alone device, other embodiments can be implemented as a system of electronically and/or communicatively coupled devices that work in concert to provide a simulated reality system, such as a mobile phone electronically coupled to a headset.

Generally, virtual reality can be viewed as a computer-generated simulated environment in which a user has an apparent physical presence. Accordingly, when implemented as a virtual reality device, simulated reality device 102 provides the user with an environment that can viewed with a head-mounted display, such as glasses or other wearable display device that has near-eye display panels as lenses, to display a virtual reality environment that visually replaces a user's view of the actual environment. When implemented as an augmented reality device, simulated reality device 102 provides a visual display that a user can see through to view the surrounding environment (e.g., the real world), and also see images of computer-generated virtual objects, such as holograms, directions, speed information, device status information, etc., that appear as a part of the environment. Augmented reality can include any type of virtual images or graphics that enhance or augment the environment that a user experiences.

To provide the user with object notification, simulated reality device 102 includes display device 104, content generation module 106, one or more sensor(s) 108, and object notification module 110.

Display device 104 represents a display device that displays images and/or information to the user. For example, display device 104 can display video of a scene occurring in the real world, stored video(s) captured at previous moment(s) in time, and/or display computer-generated video and/or images. In one or more implementations, the content displayed by display device 104 is generated and/or managed by content generation module 106. Alternately or additionally, display device 104 represents a surface on which images can be projected. For instance, in the case of augmented reality, some implementations of display device 104 represents a see-through display through which the user can view a surrounding environment and a display on which computer-generated images can be projected.

Content generation module 106 represents functionality that generates and/or drives the content displayed by, or projected on, display device 104. For example, some implementations of content generation module 106 drive display device with real-time video generated by a camera. Alternately or additionally, content generation module 106 can augment the real-time video with additional information, such as holograms, icons, location names, travel directions, and so forth. For instance, content generation module 106 can analyze a current scene being captured, generate information about the scene, and generate images that are overlaid on top of the video being displayed by display device 104. In some implementations, the overlaid information can include status and/or state information associated with simulated reality device 102 (e.g., battery level, unread messages, incoming communication notifications, etc.). As another example, content generation module 106 can generate images projected onto a surface as further described herein. In one or more implementations, content generation module 106 drives display device 104 with computer-generated graphics, such as a computer-generate scene corresponding to a virtual reality experience.

While illustrated as a single module, it is to be appreciated that content generation module 106 can include any number modules that interact with one another to provide content to display device 104. For example, content generation module 106 can include a virtual reality-based video game module that provides a virtual reality experience, and an augmentation module that augments the virtual reality experience with device information. Alternately or additionally, content generation module 106 can include a video module that streams images of a scene being captured in real-time to display device 104, a location module that analyzes and gathers information about the scene, and/or an augmentation module that augments the images of the scene with information generated by the location module.

Sensors 108 represent sensors used by simulated reality device 102 to detect the presence of a real world object. For example, sensors 108 can include a camera, a proximity sensor, light detection sensor(s), microphone(s), motion sensor(s), a Global Positioning System (GPS) sensor, and so forth. Here, the term “presence” is used to signify any suitable type of characteristic that can be determined by a sensor, such as size, distance, velocity, shape, presence, lack of presence, and so forth. For example, sensors 108 can be used to determine whether an object resides within a predetermined perimeter around, and/or distance from, simulated reality device 102, whether no objects reside with the predetermined perimeter, whether an identified object is moving towards or away from the simulated reality device, and so forth. In some implementations, sensors 108 are communicatively coupled to object notification module 110 to provide object notification in a simulated reality as further described herein.

Object notification module 110 represents functionality that identifies when to modify content being displayed (by way of content generation module 106) via display device 104, and subsequently modifies the content being displayed to notify a user of an identified object. For instance, object notification module 110 can receive information gathered and/or generated by sensors 108, and analyze the information to determine whether an object has moved within a predetermined perimeter. Upon determining that an object has moved with the predetermined perimeter, object notification module 110 can generate display data used to modify the simulated reality content being displayed by, or projected on, display device 104. Alternately or additionally, object notification module 110 can modify existing simulated reality content being displayed by, or projected on, display device 104. In some implementations, object notification module 110 works in concert with content generation module 106 to display an object notification and/or modify existing content on display device 104 to indicate the presence of an object, examples of which are further provided herein.

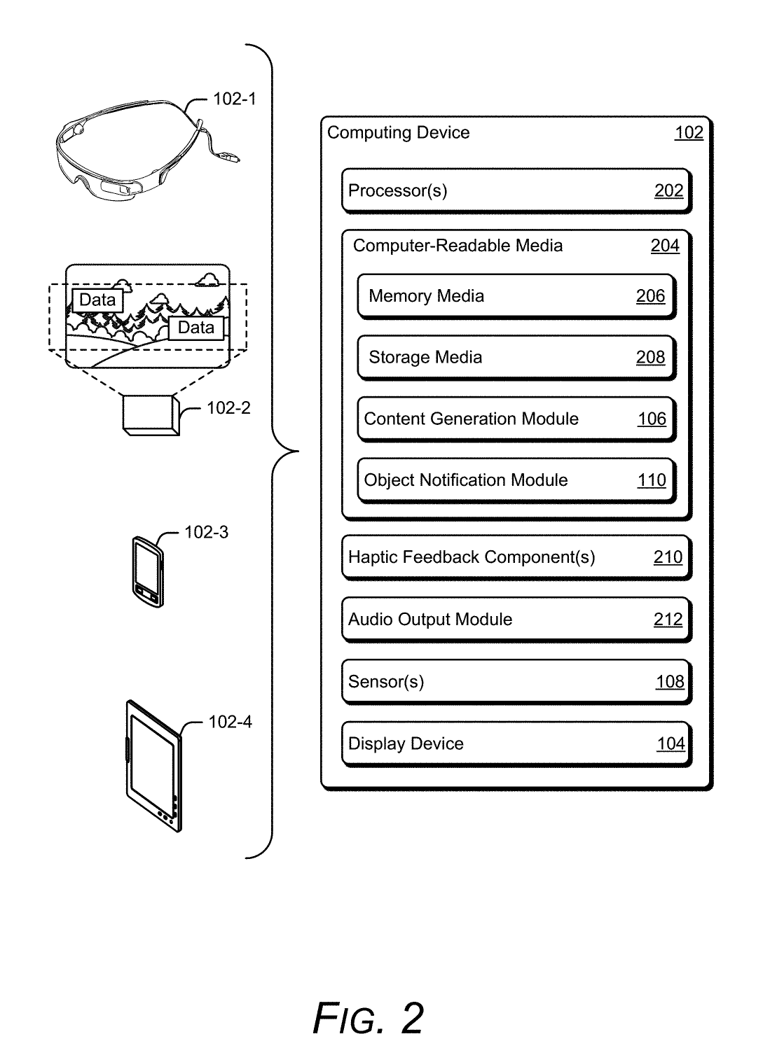

FIG. 2 illustrates an expanded view of simulated reality device 102 of FIG. 1 with various non-limiting example devices including: smart glasses 102-1, heads-up device 102-2, smart phone 102-3, and tablet 102-4. Accordingly, simulated reality device 102 represents any suitable device that incorporates object notification in a simulated reality device. Simulated reality device 102 includes processor(s) 202 and computer-readable media 204, which includes memory media 206 and storage media 208. Applications and/or an operating system (not shown) embodied as computer-readable instructions on computer-readable media 204 are executable by processor(s) 202 to provide some, or all, of the functionalities described herein. For example, various embodiments can access an operating system module that provides high-level access to underlying hardware functionality by obscuring implementation details from a calling program, such as protocol messaging, display device configuration, register configuration, memory access, and so forth.

Computer-readable media 204 includes content generation module 106 and object notification module 110 of FIG. 1. While content generation module 106 and object notification module 110 are illustrated here as residing on computer-readable media 204, they can alternately or additionally be implemented using hardware, firmware, software, or any combination thereof.

Simulated reality device 102 also includes haptic feedback component(s) 210 and audio output module 212. Haptic feedback components(s) 210 deliver tactile interactions to a user. For example, when an object of interest has been detected, some implementations use haptic feedback components 210 to deliver a physical notification and/or physical feedback to the user, such as a vibration or motion. Tactile feedback notifications can be in addition to, or alternately in place of, visual notifications associated with object detection as further described herein.

Audio output module 212 represents any suitable component that can be used to deliver audio to a user, such as a speaker, an earphone port, wireless audio transmission, etc. Upon detecting an object of interest, various implementations generate an audible notification (e.g., a beep, audible words, music, etc.). As in the case of haptic feedback components 210, audible notifications can be provided to the user in addition to, or alternately in place of, visual notifications and/or haptic notifications, to announce the presence of a detected object. Accordingly, any combination of audible, visual, and/or tactile notifications can be utilized.

As described with respect to FIG. 1, simulated reality device 102 also includes sensors 108 that are used to gather data which can be analyzed to determined when an object is present, and display device 104 which can be used to display content generated by content generation module 106 and/or object notifications generated by object notification module 110.

Having described an example operating environment in which various aspects of object notification in a simulated reality device can be utilized, consider now visually modifying simulated reality content based on object detection in accordance with one or more implementations.

### Visually Modifying Simulated Reality Content Based on Object Detection

Various implementations of simulated reality devices display computer-generated graphics, such as by generating content overlaid on an existing scene of the real world (e.g., overlaid on a video capture, projected onto a surface) or generating content that visually replaces a user's view of the real world. In turn, the user viewing these graphics sometimes becomes so engrossed in the experience, they become less aware of the real world. For instance, a VR system can provide audio output and/or tactile output that is synchronized with the computer-generated graphics such that the virtual world becomes a realistic experience to the user. Similarly, an AR system can provide graphics that engross the user, such as an animated cartoon character that interacts with various aspects of the underlying real world scene, information bubbles that include contextual data about various points of interest associated with the real world scene, device information, and so forth. While the computer-generated graphics can be entertaining to the user, these graphics can also sometimes put the user at risk.

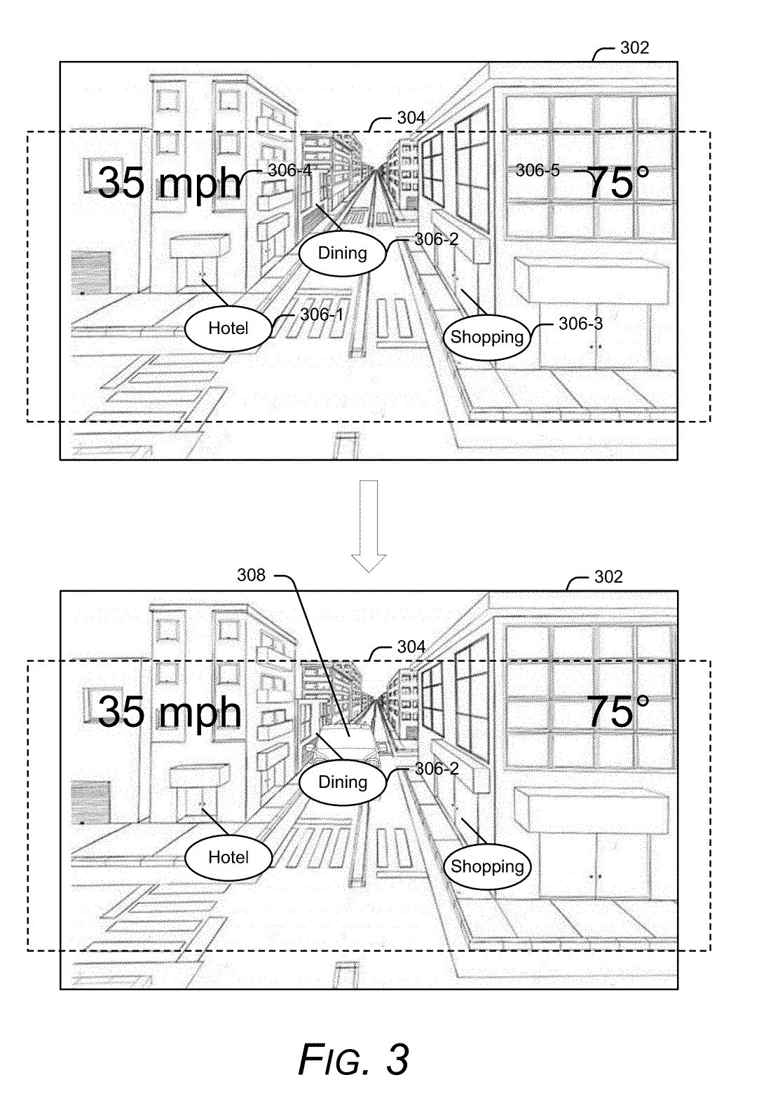

To demonstrate, consider FIG. 3 that illustrates example display content generated by a simulated reality device in the form of an augmented reality device. Here, the example display includes real world scene 302, and an augmented display 304. In some implementations, heads-up device 102-2 of FIG. 2 (not illustrated here) generates the computer images included in augmented display 304, and projects augmented display 304 on a front windshield of a car. Thus, real world scene 302 represents a view through the windshield, and augmented display 304 represents computer-generated graphics projected onto the windshield. However, other implementations of real world scene 302 and/or augmented display 304 can alternately or additionally include images viewed through a camera, captured video, and so forth

In the upper portion of FIG. 3, real world scene 302 includes a view of an arbitrary street scene. In turn, augmented display 304 provides the user with various computer-generated graphics that include information about the street scene. For example, augmented display 304 includes information bubble 306-1 that visually directs the user to a hotel included in the street scene, information bubble 306-2 that visually directs the user to a dining establishment included in the street scene, and information bubble 306-3 that visually directs the user to shopping included in the street scene. Augmented display 304 also displays travel information, illustrated here as speed information 306-4, and external temperature 306-5. However, other forms of information can be generated and displayed in augmented display 304, such as travel directions (e.g., when and where to turn, distance until next driving instruction, direction of travel, etc.), car diagnostics information (e.g., wiper fluid status, coolant level status, gas tank level status, engine temperature, battery level, etc.), etc. Heads-up device 102-2 can obtain this information in any suitable manner, such as by interfacing with a Global Positioning System (GPS), interfacing with a navigation system, interfacing with a diagnostics system, interfacing with various car sensors (e.g., rear and/or front facing cameras, external thermometers, etc.), and so forth.

While the various forms of information displayed in augmented display 304 can be helpful to the user, the additional information can distract the user from potential hazards. For example, in the lower portion of FIG. 3, the contents of real world scene 302 have change to include an approaching car 308. However, the positioning of car 308 within real world scene 302 aligns with information bubble 306-2 such that the information bubble visually obscures the approaching car. This obfuscation can put the user at risk if the user misses seeing the approaching car. Thus, while the augmented information overlays helpful information on real world scene 302, the addition of graphics can conceal objects of interest from the user.

Various implementations modify a simulated display based upon object detection. A simulated reality device displays at least some computer-generated graphics on a display, such as by visually overlaying the computer-generated graphics on a real world scene to display augmented information and/or visually replacing the real world scene with the computer-generated graphics to provide a virtual reality. While displaying the computer-generated graphics, various implementations of the simulated reality device detect a real world object, and modify the computer-generated graphics to provide a visual notification of the real world object.

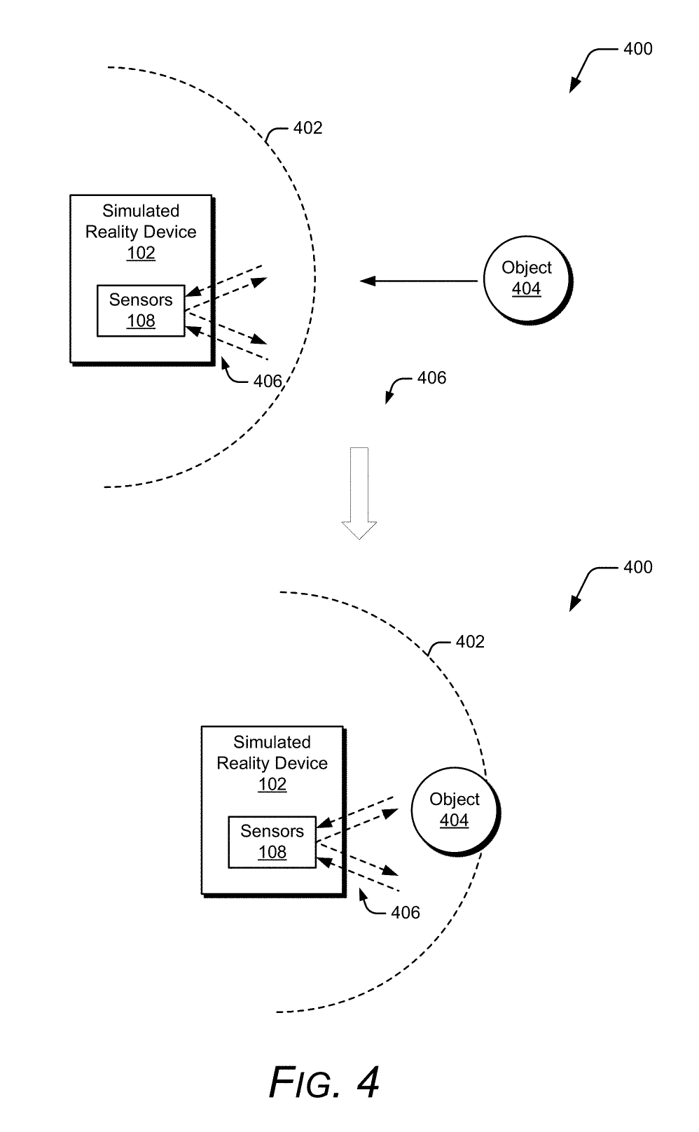

FIG. 4 illustrates an environment 400 in which a simulated reality device detects an object in accordance with one or more implementations. Environment 400 includes simulated reality device 102 of FIG. 1. As further described herein, simulated reality device 102 includes sensors 108 that can take any suitable form, such as a camera, a proximity detector, an infrared sensor, an audio detector, a radio-frequency (RF) based detector, and so forth. While sensors 108 are illustrated here as being included in simulated reality device 102, other implementations electronically and/or communicatively couple simulated reality device 102 to external sensors. As an example, instead of integrating sensors internally, a heads-up device included into a car can electronically couple to external cameras and/or proximity sensors included in the car.

In the upper portion of FIG. 4, simulated reality device 102 has predefined a region used to trigger a modification to a simulated display. Region 402 has a circular boundary around simulated reality device 102 that is determined by a predefined threshold value corresponding to the circle's radius. While described in the context of a singular value and shape (e.g., a radius and circle), any other combination of predefined shapes and/or predefined values can be used to define a boundary, region, and/or threshold without departing from the scope of the claimed subject matter.

Environment 400 also includes object 404 that represents any suitable type of real world object, such as a car, a person, a bicycle, an animal, a fixed structure, and so forth. In the upper portion of FIG. 4, object 404 is positioned outside of region 402, but is moving in a direction towards simulated reality device 102. In some implementations, sensors 108 can detect this movement and/or object 404. For example, sensors 108 can include a dual camera system that uses image captures to identify relational information between simulated reality device 102 and object 404. As another example, sensors 108 can include an RF based detection system that transmits out RF signals, and analyzes any returned RF signals that have been reflected off of object 404 to identify a size, shape, location, and/or velocity associated with the object. However, simulated reality device 102 can use other types of sensors to detect size, shape, location, and/or velocity information associated with object 404, examples of which are provided herein.

Sensors 108 can send out and/or receive sensing information 406, indicated here as outgoing and incoming information signals. For example, some implementations of sensors 108 receive incoming light to a camera lens to capture images of environment 400. In turn, the captured images can be analyzed to identify when an object of interest becomes a potential hazard. In at least some implementations, sensors 108 send out probing signals, such as a proximity sensor emitting a beam of electromagnetic radiation, and analyze return fields and/or signals for changes that indicate an object of interest has become a potential hazard. As another example, a passive motion sensor can receive and/or detect emitted infrared energy in the form of heat to identify when a motion is occurring. Thus, sensors 108 can passively receive sensing information 406 and/or actively send out probing signals to generate sensing information 406.

Moving to the lower portion of FIG. 4, object 404 has moved to a location within region 402. Accordingly, sensors 108 detect when object 404 has moved from being external to region 402 to being at, partially, and/or wholly internal to region 402. As one example, sensors 108 gather location information about object 404 using sensing information 406, and simulated reality device 102 analyzes the location information to identify when object 404 has moved to a location at or within region 402, such as by comparing the location information to a threshold value that represents the boundary of region 402. Alternately or additionally, the combination of sensors 108 and simulated reality device 102 can identify a current velocity and/or a direction movement of object 404, and compare these values to other threshold values to determine whether to notify the user about object 404. Thus, sensors 108 can be used to gather various types of information about real world objects, and a simulated reality device can analyze the information to determine if a potential hazard to the user exists. Alternately or additionally, sensors 108 can gather and analyze information about real world objects, and notify simulated reality device 102 when to modify simulated display content. When object 404 meets or exceeds object detection metrics of simulated reality device 102, such as those mentioned above, various implementations modify computer-generated graphics to display a notification of the real world object.

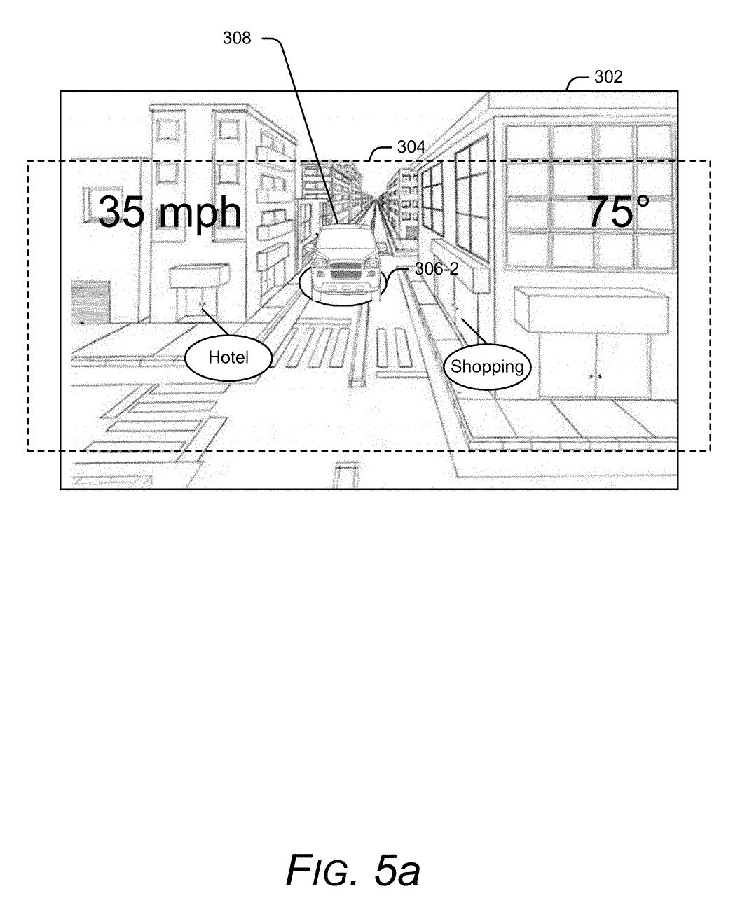

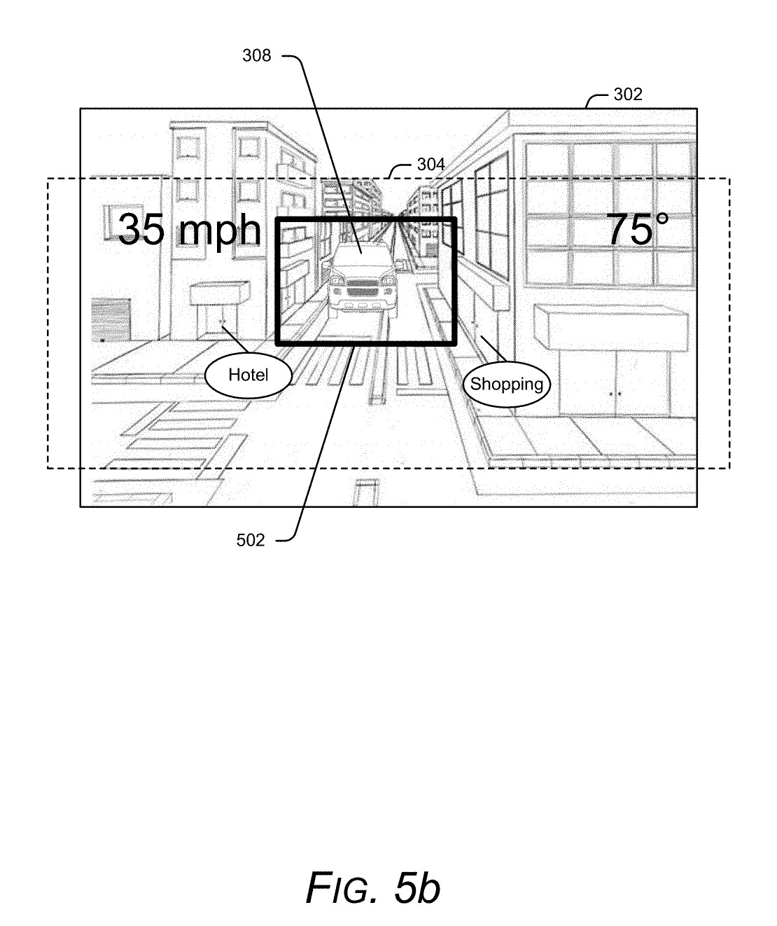

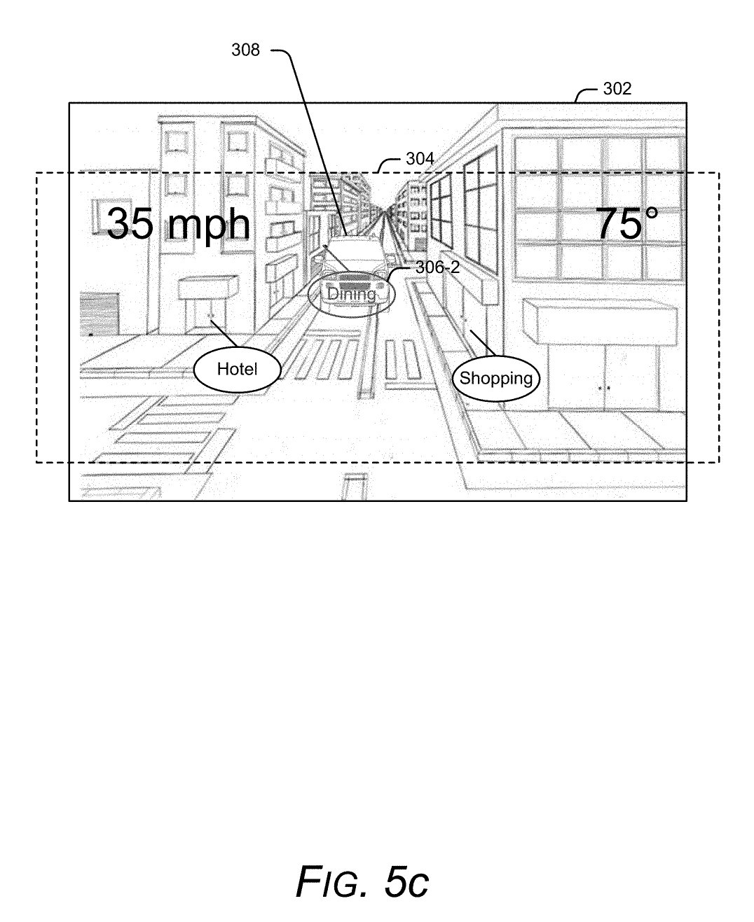

FIGS. 5a, 5b, and 5c illustrate various examples of modifying computer-generated graphics based upon object detection in accordance with one or more implementations. In some implementations, FIGS. 5a, 5b, and/or 5c represent continuations of the example described with respect to FIG. 3. Accordingly, FIGS. 5a, 5b, and 5c each include real-world display 202 and augmented display 304, where augmented display 304 is generated by heads-up device 102-2 of FIG. 2 (not illustrated here). It is to be appreciated that the examples described with respect to FIGS. 5a, 5b, and 5c are for discussion purposes, and are not intended to be limiting.

Recall from the lower portion FIG. 3 that an approaching car 308 in real world scene 302 has been obscured by computer-generated graphics displayed by augmented display 304. As further described herein, various implementations use sensors to detect an approaching object, and then determine to modify the computer-generated graphics. For example, continuing the scenario where heads-up device 102-2 has been integrated into a car, the heads-up device can interface with sensors integrated into the car, such as external cameras, and/or use sensors integrated into the heads-up device, to identify that car 308 is approaching or has moved to a location that resides at or within a predetermined distance and/or region.

In FIG. 5a, after detecting car 308, the simulated reality device modifies augmented display 304 such that information bubble 306-2 becomes a background object to the approaching car. In other words, simulated reality device 102 modifies the augmented information so that the detected real world object (e.g., car 308) becomes a foreground object relative to information bubble 306-2. This visually prioritizes the detected object over the computer-generated graphics, thus making the user more likely to see the object of interest. To determine what augmented information to move to the background, various embodiments identify a region and/or shape associated with the object of interest, and modify any displayed augmented information that falls within the identified region and/or are in contact with the shape to a background priority relative to the object of interest. While not illustrated here, various implementations provide audible and/or tactile notifications to convey an object has been detected.

Alternately or additionally, in FIG. 5b, the heads-up device modifies augmented display 304 to remove information bubble 306-2, and add a highlight notification 502 around approaching car 308. Thus, some implementations remove augmented information from augmented display 304. To determine what augmented information to visually remove, various embodiments identify a region around the object of interest, and remove any augmented information that falls within and/or is in contact with the identified region. Here, the simulated reality device also adds visual highlighting notations around the object of interest to draw more attention to the object. While illustrated here as a rectangular box around the object of interest, highlight notification 502 can take any other suitable shape, size, and/form. For example, some implementations can add animation to highlight notification 502, such as applying a shiver motion to the highlight notification, having the highlight notification expand and/or contract, and so forth. Alternately or additionally, highlight notification can include internal shading for additional emphasis. As further described herein, various implementations provide audible and/or tactile notifications to convey an object has been detected.

In FIG. 5c, the heads-up device modifies augmented display 304 by making information bubble 306-2 semi-translucent to increase the chances that a user will observe the object of interest through the computer-generated graphic. In some implementations, the simulated reality device modifies any computer-generated graphic that is in contact with the object of interest to a semi-translucent state, such as by identify a region around the object of interest, and modifying any computer-generated graphics that fall within the region to a semi-translucent state. Alternately or additionally, the simulated reality device can identify a shape, size, and/or location associated with the object of interest, and modify any computer-generated graphic that touches the object of interest. The computer-generated graphics can be altered to any percentage of translucency, such as 50% translucency, 10% translucency, 75% translucency, and so forth. As further described herein, various implementations provide audible and/or tactile notifications to convey an object has been detected.

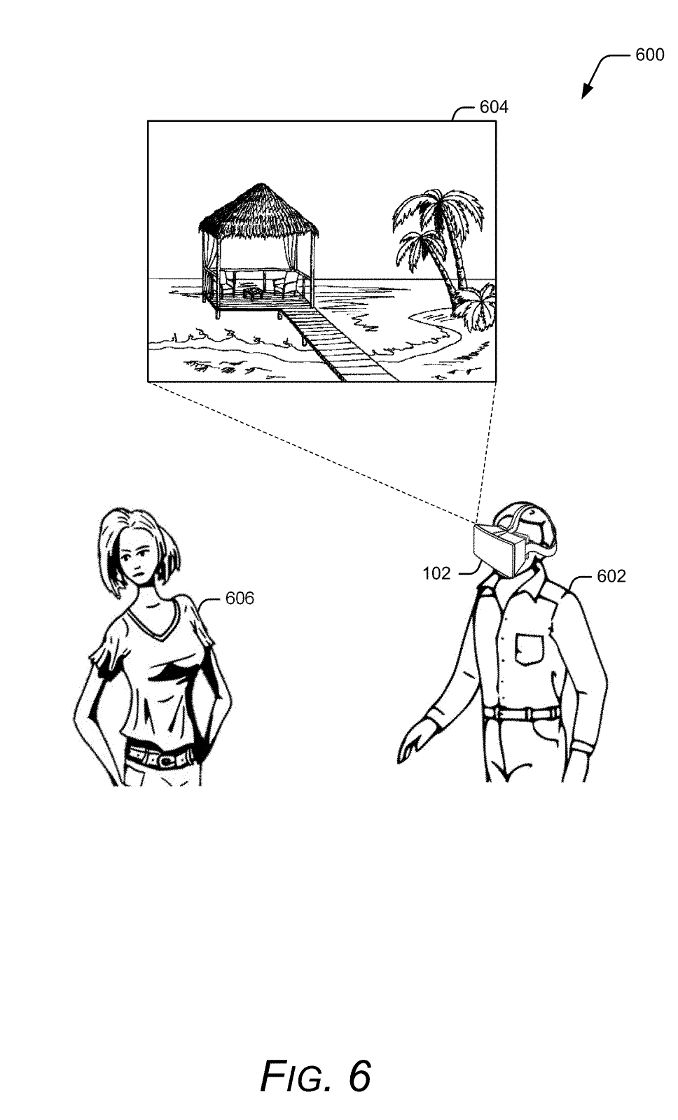

While FIGS. 5a, 5b, and 5c illustrate examples in which content corresponding to an augmented reality display is modified, other implementations can alternately or additionally modify content corresponding to a virtual reality display based upon object detection. To demonstrate, consider now FIG. 6 that illustrates environment 600. Here, environment 600 includes a user 602 that is wearing simulated reality device 102 of FIG. 1 in the form of a VR system. Here, the VR system provides user 602 with a simulated reality corresponding to a remote island. To provide this experience, simulated reality device 102 generates virtual reality display 604 that replicates a view of the remote island, and replaces the user's view of the real world with the virtual reality display. Alternately or additionally, simulated reality device 102 delivers audio and/or tactile experiences associated with the remote island to user 602 as well. Since simulated reality device 102 submerges user 602 in an alternate reality, the user can become unaware objects in environment 600. As one example, virtual reality display 604 may engross user 602 so much that the user fails to see approaching person 606. In this example, person 606 has her head turned away from user 602, thus increasing the chances that user 602 and person 606 are likely to collide. Various implementations of simulated reality device 102 detect the presences of person 606, and modify virtual reality display 604 based on this detection.

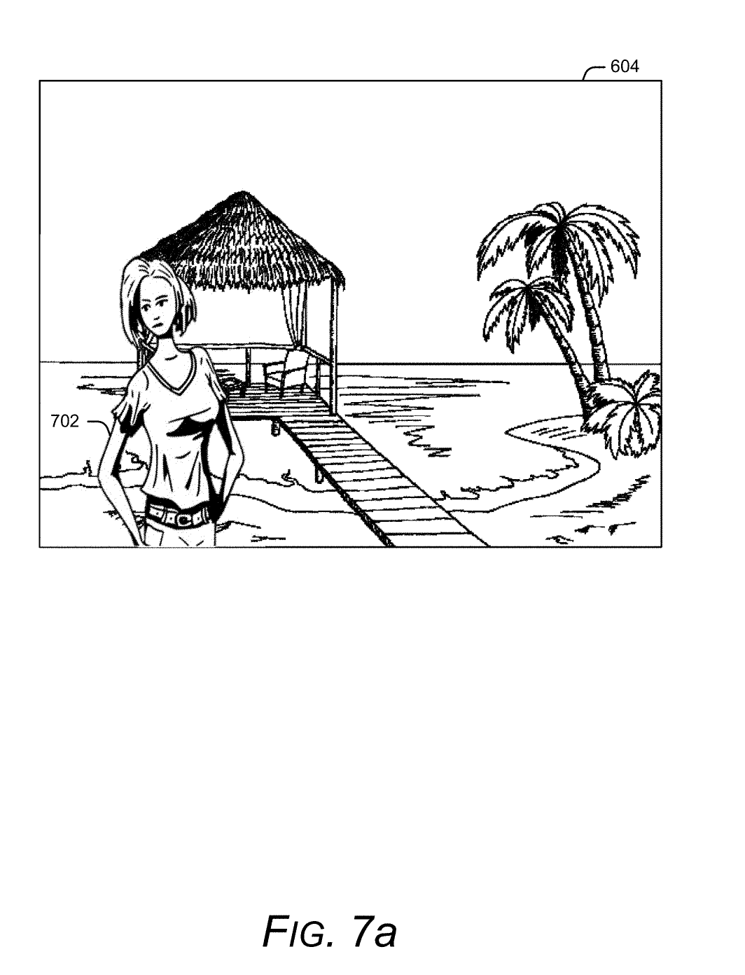

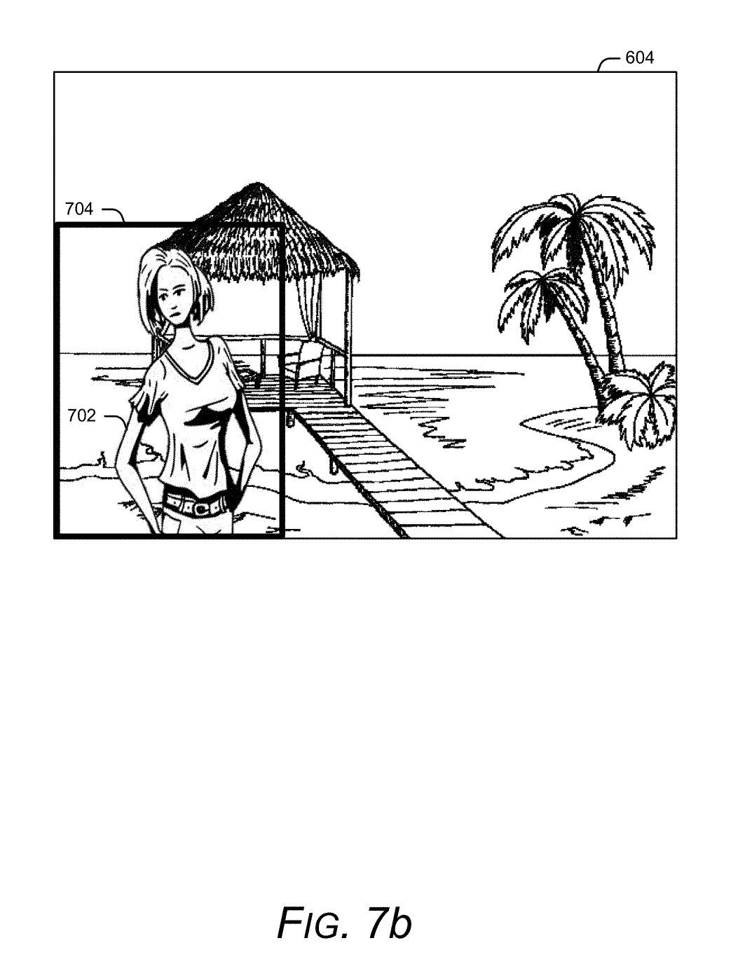

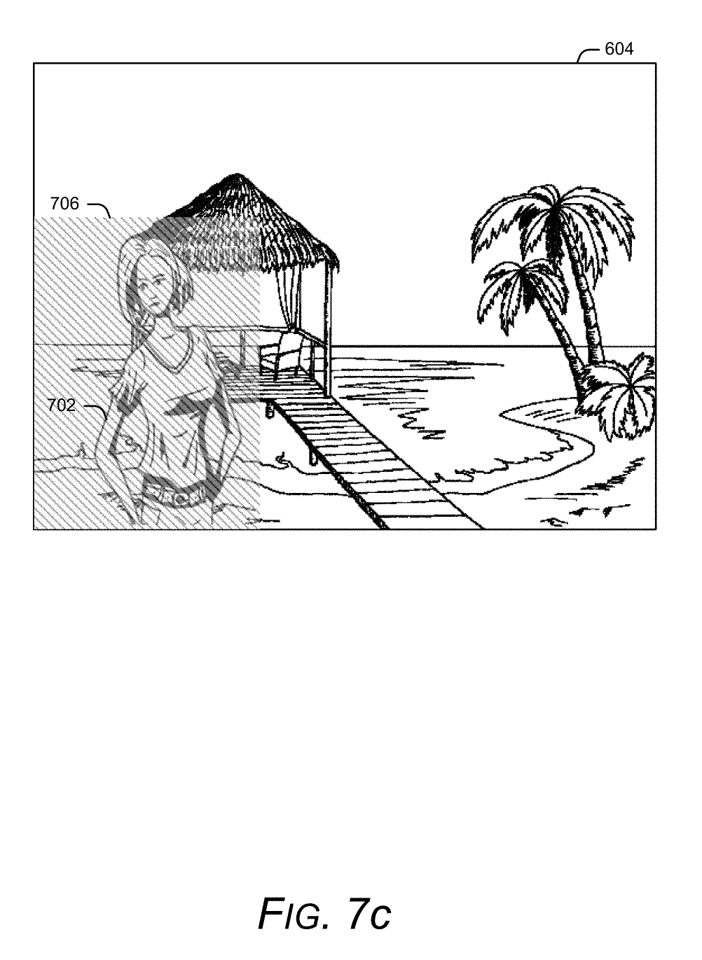

Consider now FIGS. 7a, 7b, and 7c that illustrate various examples of modifying a virtual reality display based upon object detection in accordance with one or more implementations. In some implementations, FIGS. 7a, 7b, and/or 7c represent continuations of the example described with respect to FIG. 6. Accordingly, FIGS. 7a, 7b, and 7c each include virtual reality display 604 generated by simulated reality device 102. It is to be appreciated that the examples described with respect to FIGS. 7a, 7b, and 7c are for discussion purposes, and are not intended to be limiting.

In the FIG. 7a, simulated reality device 102 has incorporated a captured image 702 of person 606. Here, the simulated reality device overlays captured image 702 on top of the virtual reality display 604. In some implementations, the simulated reality device identifies a shape of the detected object, and extracts the shape from its background as illustrated here. In other words, simulated reality device 102 extracts the shape of person 606 from environment 600 to generate captured image 702. Alternately or additionally, simulated reality device 102 overlays a captured image of the detected object in its environment and/or with the corresponding background objects (e.g., person 606 and images of the corresponding background). Sometimes the positioning of captured image 702 overlaid on virtual reality display 604 can reflect a real world position of the detected object. For example, simulated reality device 102 has overlaid captured image 702 at a left-facing position of virtual reality display 604 to indicate that the corresponding real world object is located to the front left of the simulated reality device. Similarly, simulated reality device 102 can use a center-facing position of the captured image to indicate the real world object is located in front of the simulated reality device, and a right-facing position to indicate the real world object is located to the right of the simulated reality device. In some implementations, simulated reality device 102 animates captured image 702, such as by displaying a live video of the detected object, a shuddering effect to captured image 702, an expansion and/or compression of captured image 702, or any combination thereof. Accordingly, captured image 702 can be displayed as a video or as a still image. While not illustrated here, various implementations alternately or additionally provide audible and/or tactile notifications to convey an object has been detected.

As another example, FIG. 7b illustrates captured image 702 with the addition of highlight notation 704 as a border around the captured image. As in the case of FIG. 7a, the displayed positioning of captured image 702 and/or highlight notation 704 can be used to indicate a positioning of the real world detected object relative to the simulated reality device. Highlight notation 704 can have any suitable size, shape, and/or color to notify the user of the presence of a real world object. For example, some implementations can analyze a primary color content of virtual display 604, and choose a color for highlight notation 704 that best contrasts with the primary color content relative to other colors, while other implementations use a default color. Alternately or additionally, simulated reality device 102 can animate highlight notation 704 and/or captured image 702, examples of which are provided herein. As further described herein, various implementations provide audible and/or tactile notifications to convey an object has been detected.

FIG. 7c illustrates another example of modifying a simulated reality display in accordance with one or more implementations. Similar to FIGS. 7a and 7b, FIG. 7c includes virtual reality display 604 and image capture 702. To emphasize the detection of a real world object, simulated reality device 102 additionally displays emphasis shading 706 over a region that includes captured image 702. As described with respect to highlight notation 704, emphasis shading 706 can have any suitable size, shape, color, and/or animation to help alert the user of the detected object. The notification process can alternately or additionally provide audible and/or tactile notifications to convey an object has been detected.

By modifying a simulated reality display based on object detection, a simulated reality device can provide the user with a safer viewing environment relative to an unmodified simulated reality display. The simulated reality device scans a surrounding environment for real world objects that pose a potential hazard to a user. In turn, when a real world object poses a potential hazard, the simulated reality device can visually alert the user of the hazard, such as by displaying the real world object in the foreground of the simulated reality display. Since users visually engage to experience a simulated reality, the visual notification is more likely to be observed by the user relative to other notification mechanisms. This allows the user to become submerged in a simulated reality with the added security of knowing the simulated reality device will alert the user of pending hazards.

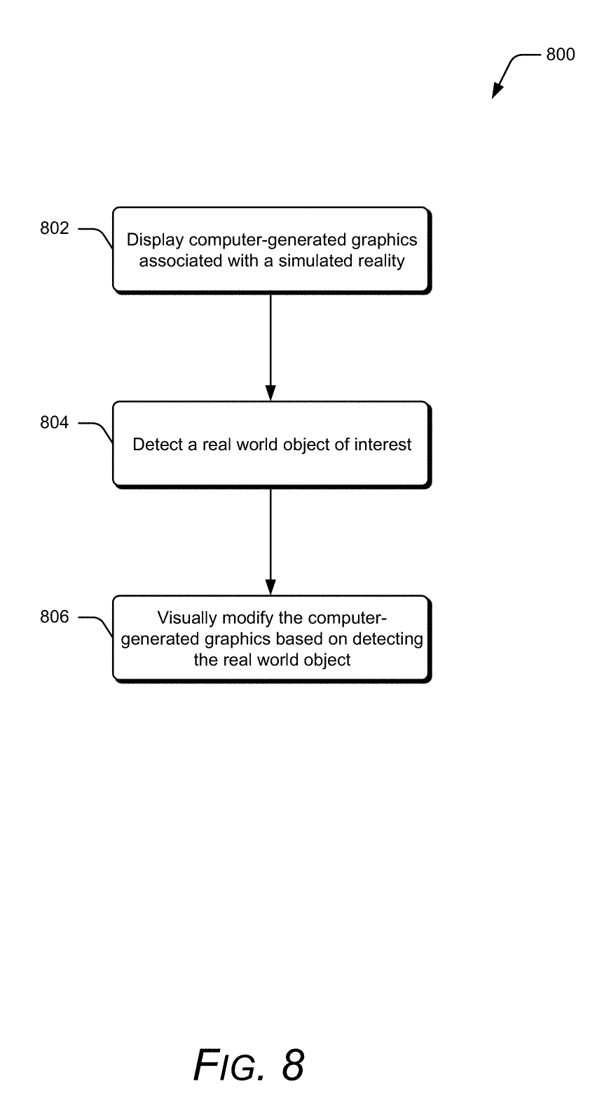

Now consider FIG. 8 that illustrates a method 800 that modifies a simulated reality display based on object detection in accordance with one or more implementations. The method can be performed by any suitable combination of hardware, software, and/or firmware. In at least some embodiments, aspects of the method can be implemented by one or more suitably configured hardware components and/or software modules, such as content generation module 106, sensor(s) 108, and/or object notification module 110 of FIG. 1. While the method described in FIG. 8 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

At 802, a simulated reality device displays computer-generated graphics associated with a simulated reality. In some implementations, the simulated reality device generates virtual reality graphics, and visually replaces a user's view of the real world with the virtual reality graphics, such as by displaying the virtual reality graphics on a display device. In other implementations, the simulated reality device generates augmented information, and visually displays the augmented information as an overlay on a scene of the real world. This can include overlaying the augmented information over a video and/or image generated by a camera, projecting the augmented information onto a window and/or view of the real world, and so forth.

At 804, the simulated reality device detects a real world object of interest. This can be achieved in any suitable manner. The simulated reality device can use one sensor to detect the real world object, or multiple sensors in combination to detect the real world object. Sensors can be integrated into the simulated reality device and/or the sensors can be external and electronically coupled to the simulated reality device. Some implementations of the simulated reality device receive triggers, events, and/or notifications from the sensors that indicate an object has been detected. Alternately or additionally, some implementations of the simulated reality device receive information gathered by the sensors, and analyze the information to detect when the real world object may pose a hazard to a user. Detecting a real world object can include detecting the presence of an object, a size of the object, a shape of the object, a direction of movement of the object, a velocity of the object, and so forth.

At 806, the simulated reality device visually modifies the computer-generated graphics based on detecting the real world object. Some implementations capture an image and/or video of the detected object, and overlay the image and/or video on a portion of the computer-generated graphics. This can include visually locating the image of the detected object at particular location to indicate a real world location of the detected object relative to the simulated reality device. Other implementations remove some or all of the computer-generated graphics, such as computer-generated graphics that are visually located in a same region as the detected object. Alternately or additionally, the simulated reality device can generate new graphics to display, such as a highlight notation, shading notation, animations, and so forth, that can be used to highlight the detected object. Alternately or additionally, some implementations provide audible and/or tactile notifications to convey an object has been detected.

Having described examples of visually modifying simulated reality graphics based on object detection, consider now a discussion of an example device in which can be used for various implementations.

### Example Device

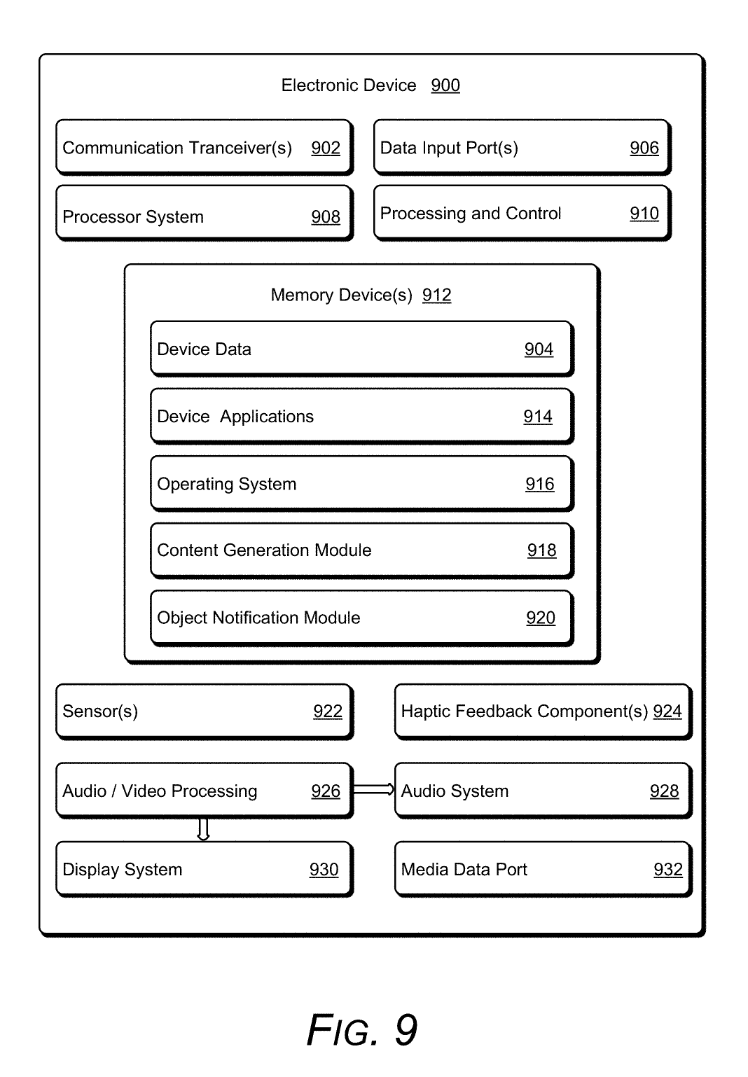

FIG. 9 illustrates various components of an example electronic device 900, such as simulated reality device 102 of FIG. 1, that can be utilized to implement various aspects as further described herein. Electronic device 900 can be, or include, many different types of devices capable of visually modifying simulated reality graphics in accordance with one or more implementations.

Electronic device 900 includes communication transceivers 902 that enable wired or wireless communication of device data 904, such as received data and transmitted data. While referred to as a transceiver, it is to be appreciated that communication transceivers 902 can additionally include separate transmit antennas and receive antennas without departing from the scope of the claimed subject matter. Example communication transceivers include Wireless Personal Area Network (WPAN) radios compliant with various Institute of Electrical and Electronics Engineers (IEEE) 802.15 (Bluetooth™) standards, Wireless Local Area Network (WLAN) radios compliant with any of the various IEEE 802.11 (WiFi™) standards, Wireless Wide Area Network (WWAN) radios for cellular telephony (3GPP-compliant), wireless metropolitan area network radios compliant with various IEEE 802.16 (WiMAX™) standards, and wired Local Area Network (LAN) Ethernet transceivers.

Electronic device 900 may also include one or more data-input ports 906 via which any type of data, media content, and inputs can be received, such as user-selectable inputs, messages, music, television content, recorded video content, and any other type of audio, video, or image data received from any content or data source. Data-input ports 906 may include Universal Serial Bus (USB) ports, coaxial-cable ports, and other serial or parallel connectors (including internal connectors) for flash memory, Digital Versatile Discs (DVDs), Compact Disks (CDs), and the like. These data-input ports may be used to couple the electronic device to components, peripherals, or accessories such as keyboards, microphones, or cameras.

Electronic device 900 of this example includes processor system 908 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively, or in addition, the electronic device can be implemented with any one or combination of software, hardware, firmware, or fixed-logic circuitry that is implemented in connection with processing and control circuits, which are generally identified as processing and control 910. Although not shown, electronic device 900 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 900 also includes one or more memory devices 912 that enable data storage, examples of which include random access memory (RAM), non-volatile memory (e.g., read-only memory (ROM), flash memory, EPROM, EEPROM, etc.), and a disk storage device. Memory devices 912 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 912 provide data storage mechanisms to store the device data 904, other types of information or data, and various device applications 914 (e.g., software applications). For example, operating system 916 can be maintained as software instructions within memory devices 912 and executed by processor system 908.

In some aspects, memory devices 912 includes content generation module 918 and object notification module 920. While these modules are illustrated and described as residing within memory devices 912, other implementations of these modules can alternately or additionally include software, firmware, hardware, or any combination thereof

Content generation module(s) 918 generate display content that can be used to provide a simulated reality display. This can include any combination of modules used to generate simulated reality content, such as a virtual reality gaming application, an augmented navigation module, an augmented hologram module, and so forth.

Object notification module 920 determines when to visually modify the simulated reality display based on object detection, and generates images and/or graphics used to modify the simulated reality display. This can include generating captured images of the detected objects and/or generating highlighting graphics as further described herein. In some implementations, object notification module 920 interfaces with sensor(s) 922 to identify objects and/or to determine when to modify the simulated reality display. Alternately or additionally, object notification module 920 interfaces with content generation module(s) 918 to drive the display of the modified content.

Electronic device 900 includes sensor(s) 922 that can be used to detect a real world object. Alternately or additionally, electronic device 900 can electronically couple to external sensors as further described herein. In some implementations, sensor(s) 922 provide information to object notification module 920 that is subsequently analyzed to determine the presence of a real world object. Alternately or additionally, sensor(s) 922 can identify the presence of the real world object, and send object notification module 920 a communication that indicates the presence of the real world object.

Electronic device 900 also includes haptic feedback component(s) 924 to deliver tactile experiences to the user, such as a vibration or motion. As further described herein, various embodiments provide the user with these tactile experiences to announce the presence of a detected object. For example, object notification module 920 can interface with haptic feedback component(s) 924 when an object has been detected to initiate a vibration, motion, etc.

Electronic device 900 also includes audio and video processing system 926 that processes audio data and passes through the audio and video data to audio system 928. Audio system 928 and display system 930 may include any modules that process, display, or otherwise render audio, video, display, or image data. Display data and audio signals can be communicated to an audio component and to a display component via a radio-frequency link, S-video link, HDMI, composite-video link, component-video link, digital video interface, analog-audio connection, or other similar communication link, such as media-data port 932. In some implementations, audio system 928 and display system 930 are external components to electronic device 900. Alternatively, or additionally, audio system 928 and/or display system 930 can be an integrated component of the example electronic device 900, such as part of an integrated speaker and/or an integrated display and touch interface. In some implementations, object notification module 920 interfaces with audio system 928 and/or display system 930 to deliver an audio alert to the user when an object has been detected as further described herein.

In view of the many possible aspects to which the principles of the present discussion may be applied, it should be recognized that the implementations described herein with respect to the drawing figures are meant to be illustrative only and should not be taken as limiting the scope of the claims. Therefore, the techniques as described herein contemplate all such implementations as may come within the scope of the following claims and equivalents thereof.

We claim:

1. A device comprising:
one or more sensors;
one or more processors; and
one or more computer-readable storage memories comprising processor-executable instructions which, responsive to execution by the one or more processors, enable the device to perform operations comprising:
displaying, on a display device, computer-generated graphics associated with a simulated reality;
detecting, using the one or more sensors, a real world object of interest; and
visually modifying the computer-generated graphics, on the display device, to display a notification that the real world object of interest has been detected.

2. The device as recited in claim 1, wherein said displaying the computer-generated graphics associated with the simulated reality further comprises displaying augmented information associated with an augmented reality.

3. The device as recited in claim 2, wherein said displaying the computer-generated graphics further comprises projecting the augmented information over a view of the real world.

4. The device as recited in claim 2, wherein said visually modifying the computer-generated graphics further comprises:
identifying a region around the object of interest;
identifying augmented information that is in contact with the region; and
visually removing the augmented information that is in contact with the region.

5. The device as recited in claim 2, wherein said visually modifying the computer-generated graphics further comprises:
identifying a region around the object of interest; and
adding a highlight notation around the region.

6. The device as recited in claim 1, wherein said visually modifying the computer-generated graphics to display the notification further comprises:
capturing one or more images of the real world object; and
overlaying the one or more images of the real world object over a virtual reality display.

7. The device as recited in claim 6, wherein said visually modifying the computer-generated graphics further comprises:
visually displaying emphasis shading in a region around the one or more images.

8. The device as recited in claim 6, wherein said overlaying the one or more images of the real world object over the virtual reality display further comprises overlaying the one or more images at a location over the virtual reality display that indicates a position of the real world object relative to the device.

9. A computer-implemented method comprising:
displaying, using a simulated reality device, computer-generated graphics associated with a simulated reality;
detecting, using one or more hardware sensors, a real world object of interest that is located at or within a predetermined distance from the simulated reality device; and
visually modifying the computer-generated graphics to display a notification associated with detecting the real world object of interest.

10. The computer-implemented method as recited in claim 9, wherein said detecting, the real world object of interest further comprises:
predefining a region around the simulated reality device using the predetermined distance to define a boundary of the region;
using the one or more hardware sensors to identify a location of the real world object of interest; and
determining the location of the real world object resides at or within the region.

11. The computer-implemented method as recited in claim 9, wherein said using the one or more hardware sensors further comprises using an external sensor that is communicatively coupled to the simulated reality device.

12. The computer-implemented method as recited in claim 11, wherein the external sensor comprises a camera.

13. The computer-implemented method as recited in claim 9, wherein said displaying the computer-generated graphics associated with the simulated reality further comprises displaying a virtual reality display associated with a virtual reality gaming application.

14. The computer-implemented method as recited in claim 13, wherein said visually modifying the computer-generated graphics to display the notification further comprises visually overlaying one or more images of the real world object on top of the virtual reality display associated with the virtual reality gaming application.

15. The computer-implemented method as recited in claim 14, wherein said visually modifying the computer-generated graphics to display the notification further comprises displaying a highlight notation around the one or more images of the real world object.

16. The computer-implemented method as recited in claim 9, wherein said visually modifying the computer-generated graphics further comprises:
identifying augmented information in an augmented reality display to modify; and
visually modifying the augmented information to a semi-translucent state.

17. A simulated reality device comprising:
a camera;
one or more processors; and
one or more computer-readable storage memories comprising processor-executable instructions which, responsive to execution by the one or more processors, enable the computing device to perform operations comprising:
displaying computer-generated graphics associated with a simulated reality display;
detecting a real world object of interest using one or more sensors;
capturing one or more images of the real world object of interest using the camera; and
visually modifying the computer-generated graphics to display the one or more images of the real world object of interest in a foreground of the simulated reality display.

18. The simulated reality device as recited in claim 17 further comprising:
one or more haptic feedback components, and
wherein said operations further comprise delivering physical feedback using the one or more haptic feedback components based on said detecting the real world object of interest.

19. The simulated reality device as recited in claim 17, wherein said displaying the computer-generated graphics associated with the simulated reality display further comprises overlaying augmented information on a scene of the real world captured by the camera to generate an augmented reality display.

20. The simulated reality device as recited in claim 17, wherein said displaying the computer-generated graphics associated with the simulated reality further comprises displaying computer-generated graphics associated with a virtual reality.
